(19) United States
(12) Patent Application Publication
(10) Pub. No.: US 2026/0189944 A1
(43) Pub. Date: Jul. 2, 2026

(54) NETWORK PERFORMANCE EVALUATION

(71) Applicant: T-Mobile USA, Inc., Bellevue, WA (US)

(72) Inventors: Prem Kumar Bodiga, Bothell, WA (US); S. Michelle Schnair, Geneva, IL (US); Narjis Tazi, Redmond, WA (US)

(21) Appl. No.: 19/006,099

(22) Filed: Dec. 30, 2024

(51) Int. Cl. H04W 24/08; H04W 8/26; H04W 64/00

(52) U.S. Cl. CPC H04W 24/08; H04W 8/26; H04W 64/00

(57) ABSTRACT

The system determines that multiple cells are configured to provide telecommunication services each cell corresponding to a frequency band of the telecommunication network. The system accesses a record of performance data of a plurality of wireless devices in communication to the cell, where a wireless device of the plurality of wireless devices is configured to communicate with one or more cells of the multiple cells, including the first cell. The system determines a first aggregated performance value for the cell by calculating a weighted aggregation of the performance data of the plurality of wireless devices. The system determines a second aggregated performance value based on aggregating the first aggregated performance values according to the one or more sectors or a geographical location corresponding to the base station.

### BACKGROUND

Wireless networks provide connectivity for mobile devices such as smartphones, tablets, and Internet of Things (IoT) sensors. These networks include base stations that transmit radio signals to cover geographic areas called cells. Mobile devices connect to the network by communicating with nearby base stations as users move between cells.

Network operators monitor and analyze the performance of their wireless networks to ensure quality of service for users. Key performance indicators (KPIs) such as signal strength, data speeds, and connection reliability are measured at both the network and device level. This data allows operators to identify areas for improvement and optimize their networks to meet increasing demands for mobile data and connectivity.

### BRIEF DESCRIPTION OF THE DRAWINGS

Detailed descriptions of embodiments of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an embodiment of a system for determining a network experience at the cell level of the telecommunication network in accordance with one or more embodiments of the present technology.

FIG. 4 illustrates a representation of the performance value for each cell in a sector in accordance with one or more embodiments of the present technology.

FIG. 5 is a flowchart for a method for determining network performance in accordance with one or more embodiments of the present technology.

FIG. 6 is a block diagram that illustrates an example of a computer system in which at least some operations described herein can be implemented.

FIG. 7 illustrates an example comparison between cell-level performance data aggregation and device-level performance data aggregation in accordance with one or more embodiments of the present technology.

FIG. 8 is an example schematic diagram illustrating a base station (also referred to as a site or a cell site) providing communication service to user devices at the radio access network (RAN) level.

The technologies described herein will become more apparent to those skilled in the art from studying the Detailed Description in conjunction with the drawings. Implementations or embodiments describing aspects of the invention are illustrated by way of example, and the same references can indicate similar elements. While the drawings depict various embodiments for the purpose of illustration, those skilled in the art will recognize that alternative embodiments can be employed without departing from the principles of the present technologies. Accordingly, while specific embodiments are shown in the drawings, the technology is amenable to various modifications.

### DETAILED DESCRIPTION

The disclosed technology relates to a system for evaluating and determining the user experience of a wireless device at the cell level of a telecommunications network based on a calculated performance value. Telecommunication networks use key performance indicators (KPIs) to evaluate a subscriber's experience on the telecommunications network. A numerical value called a performance value is calculated for each KPI to determine the severity of the performance issue associated with the KPI. The data used to determine a KPI value is included in the performance data of the telecommunication network. Existing performance tools can compile performance data at the mobile device level. However, subscriber-level performance data can mask a significant portion of user experience issues due to mobility events throughout different locations and uneven nature of network resource usages by individual users. For example, existing systems may be unable to determine which frequencies and/or antenna beams are the cause of the performance issues. These problems are also amplified when a device connects to multiple frequencies and/or beams within a given time period (e.g., one day) or when a major service disruption occurs in one frequency band for only a brief period of time (e.g., less than a minute). This causes further difficulties in diagnosing performance issues adding to the difficulties in detecting issues and fixing them at a finer granularity level to improve the subscriber experience.

The disclosed techniques focus on cell-level performance data processing, where each cell refers to a frequency band used for the communication. The performance data is based on each wireless device's network usage associated with a cell in a group of cells (e.g., multiple frequency bands) or a site (e.g., a base station). The performance data corresponds to both a cell and a device identifier such as a Mobile Station International Subscriber Directory Number (MSISDN) that is associated with each of the plurality of wireless devices. The system uses the performance data to determine an aggregated performance value for each cell. For example, the system calculates a weighted aggregation of the performance data corresponding to a predetermined time period. In some embodiments, the system determines an aggregated performance value based on the number of the wireless devices coupled to the cell. The system then determines a second aggregated performance value based on the first aggregated performance value of each cell. The second level of aggregation can be flexibly adapted based on the region of interest, such as a specific geographic location, a cell site, and/or a predefined set of devices. Information related to the individual cells does not get lost in the aggregation, thereby enabling the network operator to diagnose performance issues in a more flexible manner.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

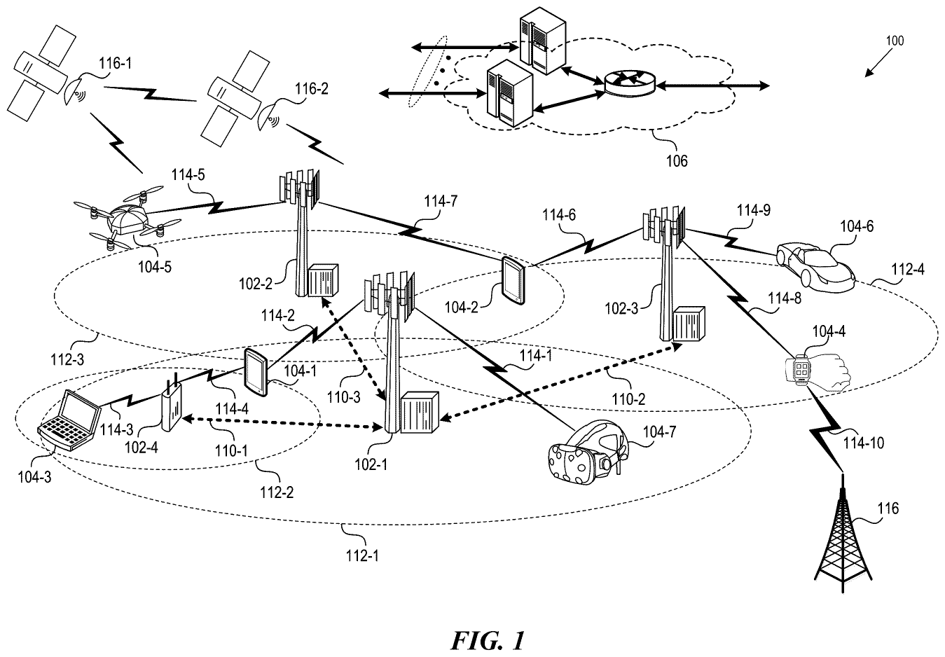

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some embodiments, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some embodiments, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some embodiments, the communication links 114 include LTE and/or mmW communication links.

In some embodiments of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

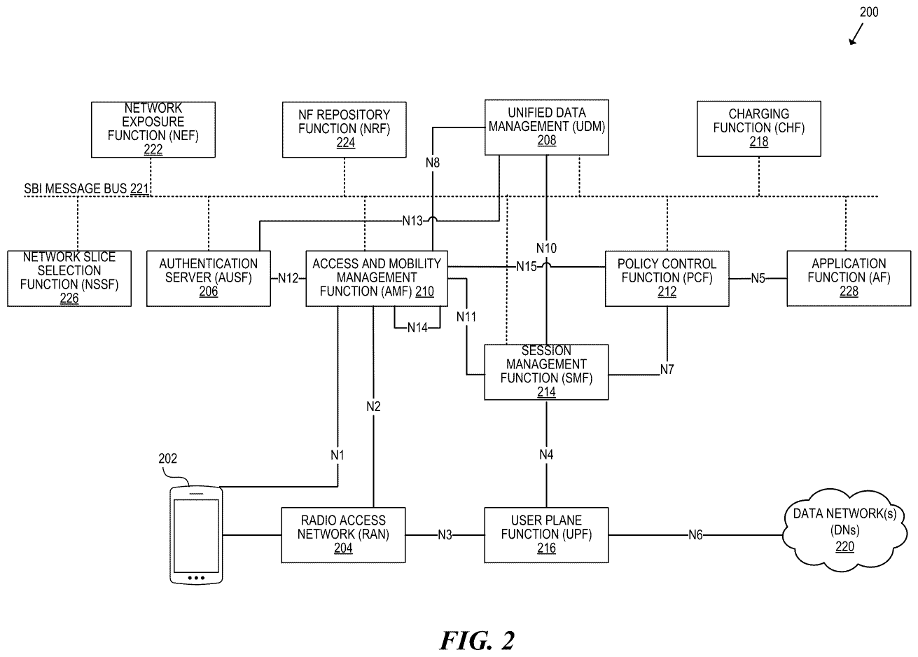

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Frequency Band Level or Beam Level Network Performance

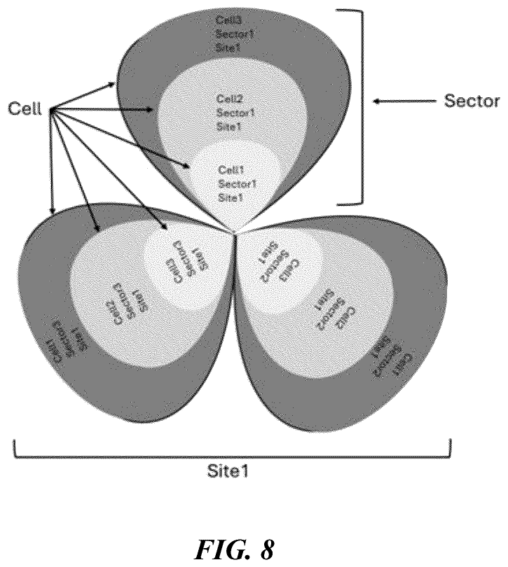

Communication in a telecommunication network can be organized into multiple levels. FIG. 8 is an example schematic diagram illustrating a base station (also referred to as a site or a cell site) providing communication service to user devices at the radio access network (RAN) level. The base station/site can have antennas facing different directions to provide a wide range of coverage. The antennas can be organized into different groups, also referred to as sectors, according to the directions of the antenna. The sectors can also be referred to as beams or beam groups. Within each sector, communication service is provided in different frequency bands. In this document, each frequency band is also referred to as a cell. A wireless device can be connected to one or more cells at the same time (e.g, with or without carrier aggregation). The wireless device can also be configured to switch between sectors (e.g., sector or beam switching a part of beam management in multi-input-multi-output, MIMO, communication). As shown in FIG. 8, in this specific example, a cell is a single-frequency band (e.g., LTE 800 MHz) emitted from a base station. The frequency band is emitted in a single direction as part of a beam. A sector represents the grouping of cell(s) in the antenna beam. For example, sector 1 can include cell1, cell2, and cell3. A site is the grouping of the one or more sectors at the base station. For example, site1 can include sector1, sector2, and sector3.

Telecommunication networks use key performance indicators (KPIs) to evaluate a subscriber's experience on the telecommunications network. For example, KPIs can be used to measure performance issues related to latency, call drops, quality of service and/or lack of coverage (LOC). A numerical value called a performance value is calculated for each KPI to determine the severity of the performance issue associated with the KPI. The data used to determine a KPI value is included in the performance data of the telecommunication network. In some embodiments, a higher KPI value can indicate a more severe issue, while a lower KPI value can indicate a less severe issue. In some embodiments, a lower KPI value corresponds to a less severe issue, and a higher KPI value corresponds to a more severe issue. In some existing systems, the KPI values can be calculated at the subscriber level due to the convenience of tracking subscriber identifiers. The subscriber-level performance data can then be aggregated and normalized at the sector level, corresponding to different antenna beam directions. However, due to subscriber mobility, a subscriber device can be connected to different Radio Access Network (RAN) nodes in different geographical locations, using different beam directions and/or frequency bands, throughout a predetermined period of time (e.g., a day, a week, a month, etc.). From a network operator's perspective, variation of services caused by mobility does not best correlate to sector-level network conditions. Furthermore, aggregating subscriber-level performance data can prevent performance issues from being detected, which causes many performance issues to be masked due to RAN nodes being unable to determine the number of devices impacted after such aggregation. For example, a relatively small number of devices (e.g., less than 10 percent of subscribers) encountering issues on a certain cell/frequency band can be masked by a majority of subscribers in the sector of multiple cells/frequency bands having no performance issues. As another example, a single device using a substantial amount of network resources can also mask issues for remaining users. Additionally, prior systems are not able to easily determine which cell(s)/frequency band(s) are the cause of the performance issues. These problems are also amplified when a device connects to multiple cells within a given time period (e.g., one day), when a major service disruption occurs in one cell for only a brief period of time (e.g., less than a minute). This causes further difficulties in diagnosing performance issues given that the performance data is associated to the subscribers, adding difficulties in detecting issues and fixing at the cell level by the network operator(s) to improve the subscriber experience.

This patent document discloses a system for diagnosing performance issues at the cell level of the telecommunication network. The system records performance data related to each wireless device that connects to a cell during the given time period (e.g., one day). The system generates a performance value for each cell and wireless device. The performance values can be aggregated or combined with subscriber-level performance value to provide a more comprehensive understanding of the network performance. Using the disclosed techniques, a network operator can determine whether a performance issue exists for one or more cells and then diagnose the performance issue by analyzing the generated performance values for each individual cell and wireless device. This prevents performance issues from being masked, decreasing the time required to remedy subscriber experience issues.

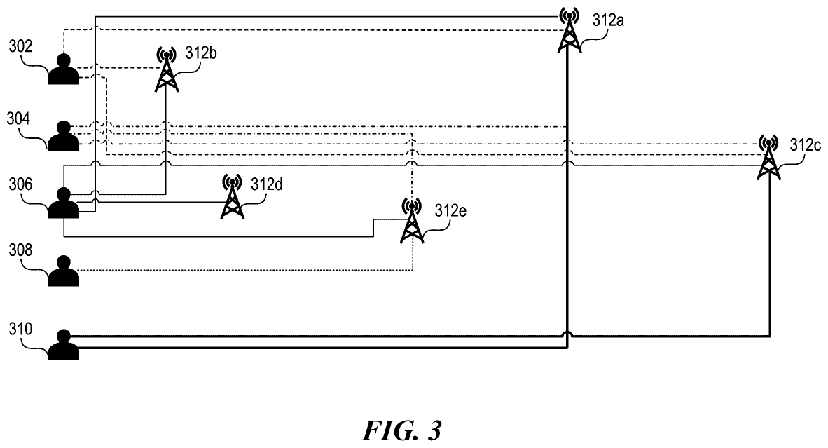

FIG. 3 illustrates an example system for determining a network experience issue at the cell level of the telecommunication network in accordance with one or more embodiments of the present technology. The telecommunication network can have multiple cells 312a, 312b, 312c, 312d, 312e. Multiple wireless devices 302, 304, 306, 308, 310 are connected to the telecommunication network, each having a corresponding MSISDN. Each wireless device 302, 304, 306, 308, 310 can connect to one or more cells and can connect to the same and/or different cells as another wireless device 302, 304, 306, 308, 310. In this document, a cell is interchangeable with a frequency band emitted by a base station, providing coverage in a geographic area. During a predetermined time period, the first wireless device 302 can connect to a first cell 312a, a second cell 312b, and a third cell 312c, either simultaneously in the case of dual/multi-connectivity or sequentially in time. During the same predetermined time period, a second wireless device 304 can connect to the first cell 312a, the third cell 312c, and a fifth cell 312e; a third wireless device 306 can connect to the first cell 312a, the second cell 312b, the third cell 312c, a fourth cell 312d, and the fifth cell 312e; a fourth wireless device 308 can connect to the fifth cell 312e, and a fifth wireless device 310 can connect to the first cell 312a and the third cell 312c. The connections can similarly be simultaneous or sequential.

In some embodiments, multiple cells (e.g., 312a, 312b, 312c, 312d, 312e) can be grouped into a cell group or a sector. Each wireless device 302, 304, 306, 308, 310 generates performance data at a cell when the wireless device 302, 304, 306, 308, 310 is connected to the cell. The performance data can be limited to a predetermined time period, such as an hour, day, week, month, etc. The performance data is associated with a wireless device 302, 304, 306, 308, 310, where each wireless device 302, 304, 306, 308, 310 has a corresponding MSISDN. Performance data can be generated based on a wireless device's interactions with the cell. The performance data is used to determine a performance value for each cell. Multiple performance values can be determined for each cell and each group of cells (e.g., for carrier aggregation). A performance value can have a corresponding KPI to indicate the type of performance issue the performance value represents. For example, the KPIs can include voice drop count, Reference Signal Received Power (RSRP), latency, radio frequency leakage, LOC, and/or percentage in performance drop. RSRP is a measurement of the strength of a wireless signal in a cell network and is used to evaluate network coverage and communication stability. Latency is the delay in network communication and shows the time that data takes to transfer across the network. Radio access leakage refers to an amount of time a wireless device spends connected to a below optimal network. For example, the amount of time a 5G enabled wireless device is connected to a 3G or 4G network during the predetermined time period, as compared to the 5G network, can indicate whether radio access leakage has occurred. LOC refers to the area in the connection range of the cell where a wireless device is unable to connect to the cell. In some embodiments, each KPI or performance value can be specific to different operating systems of the wireless devices connected to the cell (e.g., Android or non-Android devices) and/or the generation of the wireless network (e.g., 3G, 4G, long-term evolution (LTE), or 5G).

In some embodiments, the system records performance data for each MSISDN at each of the multiple cells 312a, 312b, 312c, 312d, 312e. The system identifies one or more KPIs, based on the performance data to calculate a performance value or cell score. A performance value modifier is determined for each performance value. The performance value modifier can either add or deduct from the performance value to indicate a change or decrease in the performance or user experience of the wireless device 302, 304, 306, 308, 310. The performance value modifier is determined from the performance data. For example, when the performance value represents a latency KPI, a latency value of 75 milliseconds in the performance data can have a certain deduction or change from baseline, such as a 0.3, and a latency value of 82.5 milliseconds can have a deduction or change of 0.6. The baseline performance value can be uniform between different KPIs or vary depending on the KPI. In some embodiments, only a value beyond a threshold value contributes to the deduction or change from the baseline performance value. In some other embodiments, the deduction or change from the baseline is determined using a machine learning model. The machine learning model can be trained using historical performance data and predefined training data indicating how the data relates to a given KPI, along with a severity rating for each KPI. The performance value modifier can be normalized based on a predetermined scale (e.g., 0-1, 1-10, 1-100, etc.). The performance value is then determined by adding or deducting the performance value modifier from a baseline performance value. A performance value modifier and performance value can be determined for each wireless device 302, 304, 306, 308, 310 that connected to the cell 312a, 312b, 312c, 312d, 312e during the predefined time period.

In some embodiments, the performance value modifier for each wireless device 302, 304, 306, 308, 310 at the cell level is aggregated based on the total number of wireless devices so as to calculate a single aggregated performance value for each of the multiple cells 312a, 312b, 312c, 312d, 312e. For example, each performance value modifier associated with a wireless device (e.g., using the wireless device's MSISDN) is averaged based on the total number of wireless devices connected to the cell. In some embodiments, the median cell value or a weight average value can be used. The aggregated performance value can then be determined by adding or deducting the average performance value modifier from the baseline performance value. The aggregated performance value can also be calculated by summing the performance values of each wireless device 302, 304, 306, 308, 310 and then dividing the sum by the total number of performance values, where the total number of performance values is based on the total number of wireless devices that connected to the cell 312a, 312b, 312c, 312d, 312e during the predetermined time period (e.g., an hour, a day, etc.). Example aggregation approaches are shown in Equations (1)-(3) below.

$$Average ( cell\_score ) \qquad Eq . ( 1 )$$

$$Median ( cell\_score ) \qquad Eq . ( 2 )$$

$$10 - ( ( {\sum }_{i = 1}^{n} \frac{{Cell\_Deduction}_{i} \times {Sub\_Volumn}_{i}}{{Sub\_Volumn}_{i}} ) \times weight ) \qquad Eq . ( 3 )$$

Example calculation of cell performance deduction is shown in Equation (4) below.

$$\frac{\sum ( KPI\_Cell \_Deduction )}{cell count} \qquad Eq . ( 4 )$$

In some embodiments, performance deductions based on subscriber interactions on a cell can be calculated as shown in Equation (5) below. The example metric here represents every interaction subscribers have on the cell(s), which exceeds the actual unique subscriber volume on the respective cells.

$$\frac{\sum ( daily\_KPI \_Deduction \_subVolume )}{\sum ( daily\_KPI \_subVolume )} \qquad Eq . ( 5 )$$

In some other embodiments, the system calculates multiple performance values for each cell. Each performance value can represent a different KPI. The multiple performance values can be weighted, for example, based on the severity of the performance issue associated with the KPI. Each performance value can then be aggregated based on the assigned weighting to determine a single performance value for the cell.

The system then determines a second aggregated performance value for the group of cells. The system aggregates the performance value of each of the multiple cells 312a, 312b, 312c, 312d, 312e to calculate a single performance value for the sector, the site, or a geographical location corresponding to multiple sites.

The ability to aggregate performance values first at the cell level enables the network operator to better diagnose and understand performance issues affecting the telecommunication network. For example, the first wireless device 302 can use a majority of the bandwidth on the first cell 312a but experience no performance issues. The second wireless device 304, the third wireless device 306, and the fifth wireless device 310 can use the remaining bandwidth on the first cell 312a, but experience performance issues. In some existing performance analysis systems, performance data from the first wireless device 302 can mask the performance issues experienced by the second wireless device 304, the third wireless device 306, and/or the fifth wireless device 310 due to the bandwidth usage of the first wireless device 302. System implemented using the disclosed techniques, on the other hand, can determine the performance value for an individual wireless device connected to a cell, enabling a network operator to detect and correct performance issues at a much finer granularity level.

In another example, the second wireless device 304, the third wireless device 306, and the fifth wireless device 310 can connect to the first cell 312a and experience no performance issues, while wireless device 302 can connect to the first cell 312a and experience performance issues. The system can detect the performance issues of the first wireless device 302 by determining a performance value for each wireless device connected to the first cell 312a during the predetermined time period. Often times, network issues are confined to individual cells and network nodes (e.g., wireless devices) in communication with the cells; therefore, determining a performance value for each cell and network node generates a simpler dataset to enable a user to localize any performance issues and correct the problems at each cell and/or network node.

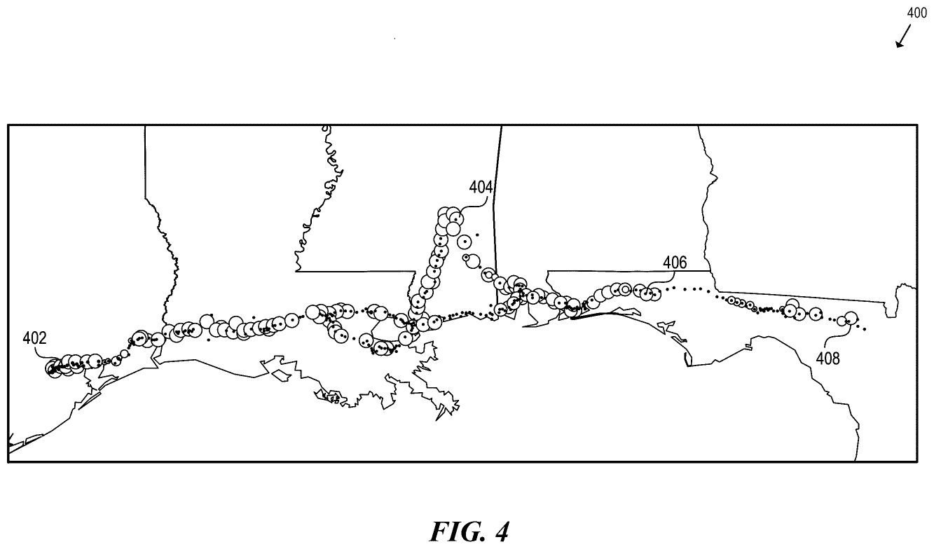

FIG. 4 illustrates a representation of the performance value for each cell in a geographic area that a wireless device connected to. Each dot or point on the map 400 can represent a cell or a sector. In some embodiments, each circle can represent a cell site. In some embodiments, the size of the point can be indicative of the performance value. For example, a larger point can represent a larger deduction or change from the baseline performance value, which signifies a more significant performance issue.

A wireless device can connect to the first cell 402, the second cell 404, the third cell 406, and the fourth cell 408 in addition to every other cell in various sectors and various sites. The system enables a network operator to view the performance value at a finer granularity for each cell and at a coarser granularity (e.g., a site or a geographical location) when needed. As compared to some existing approaches, where a single performance value for each wireless device is determined and then assigned to a corresponding sector. Systems implemented using the disclosed techniques enable a user to determine how each cell affected the wireless device's performance, each cell's individual performance, and how each cell affects the overall performance of the network (e.g., in beamforming, at the RAN level, and/or in geographic areas). For example, in some existing approaches, even though the second cell 404 contributed under 3 percent to the overall performance value, the entire performance score (e.g., deduction or change from baseline) was attributed to the sector that the second cell 404 is a part of. It is thus not feasible to provide finer reconfiguration of the network at the frequency band level to achieve better user experience. The disclosed techniques enable a network operator to determine that, in actuality, over 200 of the 500 cells connected to contributed to the performance issues and multiple cells had a similar impact on the performance issues experienced by the wireless devices, thereby allowing proper reconfigurations of the network to allow better usages of the network resources.

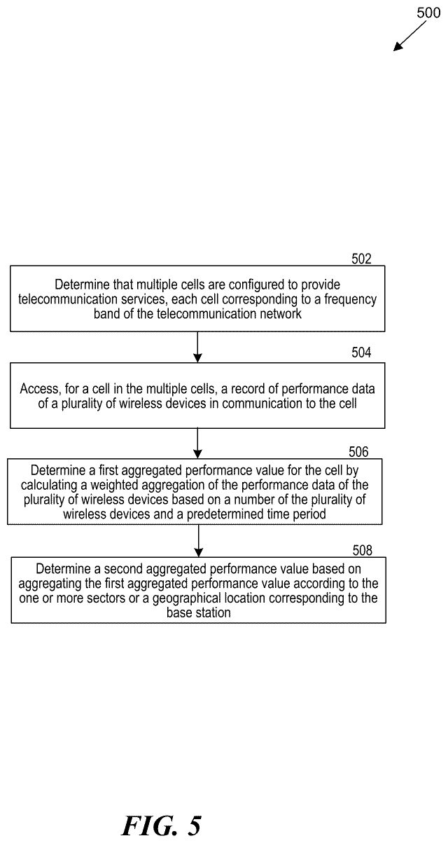

FIG. 5 is a flowchart illustrating a process 500 performed by the disclosed system. Process 500 can be performed by a system of a telecommunications network. In one example, the system includes at least one hardware processor and at least one non-transitory memory storing instructions, which, when executed by at least one hardware processor, cause the system to perform the process 500.

At 502, the system determines that multiple cells of a telecommunication network are configured to provide telecommunication services, each cell corresponding to a frequency band of the telecommunication network. The multiple cells are organized into one or more sectors and each of the one or more sectors corresponds to a beam or a group of beams associated with one or more antennas of a base station. At 504, the system accesses, for a cell of the multiple cells, a record of performance data of a plurality of wireless devices in communication to the cell. A wireless device of the plurality of wireless devices is configured to be in communication with one or more cells of the multiple cells including a first cell. The performance data is associated with a Mobile Station International Subscriber Directory Number (MSISDN) associated with each of the plurality of wireless devices.

At 506, the system determines a first aggregated performance value for the cell by calculating a weighted aggregation of the performance data of the plurality of wireless devices based on a number of the plurality of wireless devices and a predetermined time period. For example, the performance value can indicate a severity of: number of voice drops, number of access failures, latency, radio frequency leakage, low coverage issues, or lack of coverage. In some embodiments, the system determines a performance value modifier for each of the plurality of wireless devices in communication to the cell. The performance value modifier indicates an amount the performance value to be changed from a baseline performance value. The system aggregates each performance value modifier based on a number of wireless devices connected to the cell to determine a single performance value modifier for the cell. In some other embodiments, the system can further deduct the performance value modifier from the baseline performance value. In yet some other embodiments, the system can further determine an individual performance value for each of the plurality of wireless devices in communication to the cell.

In some embodiments, the system determines multiple aggregated performance values for the cell, where each of the multiple aggregated performance values corresponds to a different performance issue extrapolated from the performance data. In some embodiments, the system determines each of the multiple aggregated performance values for the cell based on a predetermined severity of the corresponding performance issue and determines a single aggregated performance value based on the weighted multiple aggregated performance values. At 508, the system determines a second aggregated performance value according to the one or more sectors or a geographical location corresponding to the base station. In some embodiments, the second aggregated performance value can be determined based on network operators' needs, such as aggregation based on cross-regional traffic shift and custom cluster aggregations (e.g., special events, disaster areas, etc.). Having the second level of aggregations ensures that stable performance data constructed based on the first level of aggregation can be provided in a flexible manner to achieve different performance goals for the network operators.

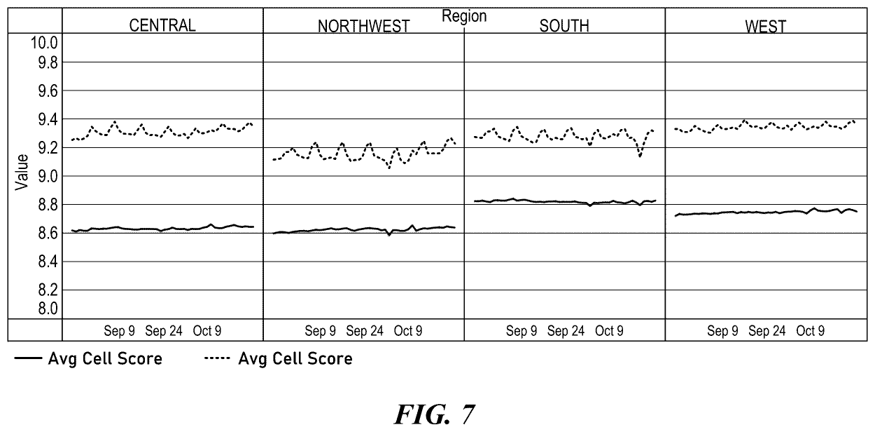

The disclosed techniques can be implemented to provide a normalized view of the network performance and be scalable based on the size of the network and/or the number of user devices. The disclosed techniques also enable stable and consistent comparisons among different network node hierarchies and timeframes, as shown in FIG. 7 with a comparison to prior mobile device level approaches. The disclosed techniques further allow easy identification of anomalous events.

### Computer System

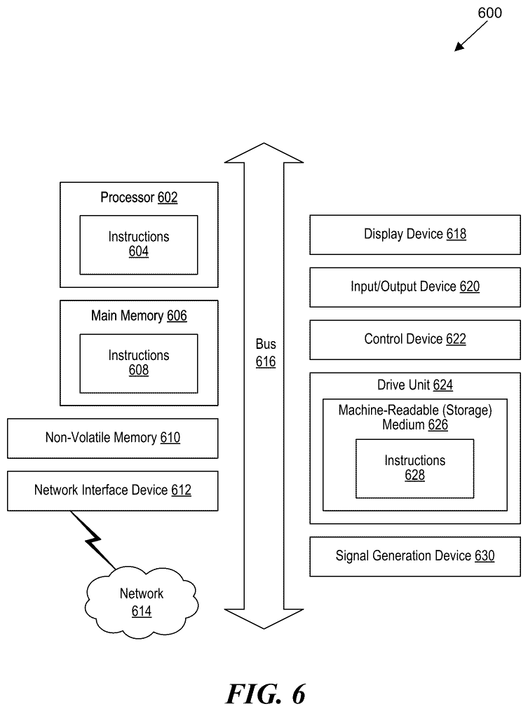

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some embodiments, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although embodiments have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the embodiments. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative embodiments can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative embodiments can employ differing values or ranges.

Details of the disclosed embodiments can vary considerably in specific embodiments while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative embodiments can include additional elements to those embodiments described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further embodiments of the invention.

To reduce the number of claims, certain embodiments are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A non-transitory, computer-readable storage medium comprising instructions recorded thereon, wherein the instructions when executed by at least one data processor of a system, cause the system to:
determine that multiple cells of a telecommunication network are configured to provide telecommunication services, each cell corresponding to a frequency band of the telecommunication network,
wherein the multiple cells are organized into one or more sectors, and
wherein each of the one or more sectors corresponds to a beam or a group of beams associated with one or more antennas of a base station;
access, for a cell of the multiple cells, a record of performance data of a plurality of wireless devices in communication to the cell,
wherein a wireless device of the plurality of wireless devices is configured to be in communication with one or more cells of the multiple cells including a first cell, and
wherein the performance data is associated with a Mobile Station International Subscriber Directory Number (MSISDN) associated with each of the plurality of wireless devices;
determine a first aggregated performance value for the first cell by calculating a weighted aggregation of the performance data of the plurality of wireless devices based on a number of the plurality of wireless devices and a predetermined time period; and
determine a second aggregated performance value based on aggregating the first aggregated performance value according to the one or more sectors or a geographical location corresponding to the base station.

2. The non-transitory, computer-readable storage medium of claim 1, wherein determining the first aggregated performance value further causes the system to:
determine a performance value modifier for each of the plurality of wireless devices in communication to the cell,
wherein the performance value modifier indicates an amount the performance value to be changed from a baseline performance value; and
aggregate each performance value modifier based on a number of wireless devices connected to the cell to determine a single performance value modifier for the cell.

3. The non-transitory, computer-readable storage medium of claim 2, wherein the instructions further cause the system to:
deduct the performance value modifier from the baseline performance value.

4. The non-transitory, computer-readable storage medium of claim 2, wherein the instructions further cause the system to:
determine an individual performance value for each of the plurality of wireless devices in communication to the cell.

5. The non-transitory, computer-readable storage medium of claim 1, wherein the instructions further cause the system to:
determine multiple aggregated performance values for the cell,
wherein each of the multiple aggregated performance values corresponds to a different performance issue extrapolated from the performance data.

6. The non-transitory, computer-readable storage medium of claim 5, wherein the instructions further cause the system to:
determine each of the multiple aggregated performance values for the cell based on a predetermined severity of the corresponding performance issue; and
determine a single aggregated performance value based on the weighted multiple aggregated performance values.

7. The non-transitory, computer-readable storage medium of claim 5, wherein the performance value indicates a severity of: number of voice drops, number of access failures, latency, radio frequency leakage, low coverage issues, or lack of coverage.

8. A system comprising:
at least one hardware processor; and
at least one non-transitory memory storing instructions, which, when executed by the at least one hardware processor, cause the system to:
determine that multiple cells of a telecommunication network are configured to provide telecommunication services each cell corresponding to a frequency band of the telecommunication network,
wherein the multiple cells are organized into one or more sectors, and
wherein each of the one or more sectors corresponds to a beam or a group of beams associated with one or more antennas of a base station;
access, for a cell of the multiple cells, a record of performance data of a plurality of wireless devices in communication to the cell,
wherein a wireless device of the plurality of wireless devices is configured to be in communication with one or more cells of the multiple cells including a first cell, and
wherein the performance data is associated with a Mobile Station International Subscriber Directory Number (MSISDN) associated with each of the plurality of wireless devices;
determine a first aggregated performance value for the cell by calculating a weighted aggregation of the performance data of the plurality of wireless devices based on a number of the plurality of wireless devices and a predetermined time period; and
determine a second aggregated performance value based on aggregating the first aggregated performance value according to the one or more sectors or a geographical location corresponding to the base station.

9. The system of claim 8, wherein determining the first aggregated performance value further causes the system to:
determine a performance value modifier for each of the plurality of wireless devices in communication to the cell,
wherein the performance value modifier indicates an amount the performance value to be changed from a baseline performance value; and
aggregate each performance value modifier based on a number of wireless devices connected to the cell to determine a single performance value modifier for the cell.

10. The system of claim 9, further caused to:
deduct the performance value modifier from the baseline performance value.

11. The system of claim 9, further caused to:
determine an individual performance value for each of the plurality of wireless devices in communication to the cell.

12. The system of claim 8, further caused to:
determine multiple aggregated performance values for the cell,
wherein each of the multiple aggregated performance values corresponds to a different performance issue extrapolated from the performance data.

13. The system of claim 12, further caused to:
determine each of the multiple aggregated performance values for the cell based on a predetermined severity of the corresponding performance issue; and
determine a single aggregated performance value based on the weighted multiple aggregated performance values.

14. The system of claim 12, wherein the performance value indicates a severity of: number of voice drops, number of access failures, latency, radio frequency leakage, low coverage issues, or lack of coverage.

15. A method for determining network performance, comprising:
determining that multiple cells of a telecommunication network are configured to provide telecommunication services each cell corresponding to a frequency band of the telecommunication network,
wherein the multiple cells are organized into one or more sectors, and
wherein each of the one or more sectors corresponds to a beam or a group of beams associated with one or more antennas of a base station;
accessing, for a cell of the multiple cells, a record of performance data of a plurality of wireless devices in communication to the cell,
wherein a wireless device of the plurality of wireless devices is configured to be in communication with one or more cells of the multiple cells including a first cell, and
wherein the performance data is associated with a Mobile Station International Subscriber Directory Number (MSISDN) associated with each of the plurality of wireless devices;
determining a first aggregated performance value for the cell by calculating a weighted aggregation of the performance data of the plurality of wireless devices based on a number of the plurality of wireless devices and a predetermined time period; and
determining a second aggregated performance value based on the first aggregated performance value according to the one or more sectors or a geographical location corresponding to the base station.

16. The method of claim 15, wherein determining the first aggregated performance value further comprises:
determining a performance value modifier for each of the plurality of wireless devices in communication to the cell,
wherein the performance value modifier indicates an amount the performance value to be changed from a baseline performance value; and
aggregating each performance value modifier based on a number of wireless devices connected to the cell to determine a single performance value modifier for the cell.

17. The method of claim 16, further comprising:
deducting the performance value modifier from the baseline performance value.

18. The method of claim 16, further comprising:
determining an individual performance value for each of the plurality of wireless devices in communication to the cell.

19. The method of claim 15, further comprising:
determining multiple aggregated performance values for the cell,
wherein each of the multiple aggregated performance values corresponds to a different performance issue extrapolated from the performance data.

20. The method of claim 19, further comprising:
determining each of the multiple aggregated performance values for the cell based on a predetermined severity of the corresponding performance issue; and
determining a single aggregated performance value based on the weighted multiple aggregated performance values.
